(19) United States
(12) Patent Application Publication
(10) Pub. No.: US 2006/0259577 A1
(43) Pub. Date: Nov. 16, 2006

(54) System and method for customizing services for applications

(76) Inventors: Brindusa Fritsch, Toronto (CA); Viera Bibr, Kilbride (CA); Michael Shenfield, Richmond Hill (CA); Sean Paul Taylor, Milton (CA); Michael Matovsky, Toronto (CA); Kamen Vitanov, Mississauga (CA)

Correspondence Address: Gowling Lafleur Henderson LLP, 2600-160 Elgin Street, Ottawa, ON, K1P 1C3, CA

(21) Appl. No.: 11/405,532

(22) Filed: Apr. 18, 2006

Related U.S. Application Data
(60) Provisional application No. 60/672,039, filed on Apr. 18, 2005.

(51) Int. Cl. G06F 15/16

(52) U.S. Cl. 709/217

(57) ABSTRACT

A system and method of customizing services on a wireless device are provided. The system comprises a device and an application gateway server for communicating with the device. The device has a device runtime environment having core services, a default system application and at least one custom system application. The application gateway server configured for communication with a default back-end service and at least one custom back-end service. The at least one custom back-end service provides customized services to the device. The method comprises the steps of configuring a device runtime environment with core services, a default system application and at least one custom system application, and communicating with at least one custom back-end service to customize services of the device.

This non-provisional application claims benefit to U.S. Provisional Application 60/672,039 filed on Apr. 18, 2005, which is hereby incorporated by reference.

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

The present patent disclosure relates generally to a communication system for providing communication to a plurality of devices and specifically to a system and method for customizing services for such devices.

### BACKGROUND

Due to the proliferation of wireless networks, there are a continually increasing number of wireless devices in use today. These devices include mobile telephones, personal digital assistance (PDAs) with wireless communication capabilities, two-way pagers and the like. Concurrently with the increase of available wireless devices, software applications running on such devices have increased their utility. For example, the wireless device may include an application that retrieves a weather report for a list of desired cities or an application that allows a user to shop for groceries. These software applications take advantage of the ability to transmit data of the wireless network in order to provide timely and useful services to users, often in addition to voice communication. However, due to a plethora of different types of devices, restricted resources of some devices, and complexity of delivering large amounts of data to the devices, developing software applications remains a difficult and time-consuming task.

Currently, devices are configured to communicate with Web services through Internet-based browsers and/or native applications. Browsers have the advantage of being adaptable to operate on a cross-platform basis for a variety of different devices, but have a disadvantage of requesting pages (screen definitions in HTML) from the Web service, which hinders the persistence of data contained in the screens. A further disadvantage of browsers is that the screens are rendered at runtime, which can be resource-intensive. Applications for browsers are efficient tools for designing platform independent applications. Accordingly, different runtime environment (RE)s, regardless of the platform, execute the same application. However, since different wireless devices have different capabilities and form factors, the application may not be executed or displayed as desired. Further, browser based application often require significant transfer bandwidth to operate efficiently, which may be costly or even unavailable for some wireless devices.

On the other hand, native applications are developed for a specific wireless device platform, thereby providing a relatively optimized application program for a runtime environment running on that platform. However, a platform dependent application introduces several drawbacks, including having to develop multiple versions of the same application and being relatively large in size, thereby taxing memory resources of the wireless device. Further, application developers need experience with programming languages such as Java and C++ to construct such native applications.

Another issue is the “one size fits all” approach to services available on wireless devices. Because of limited resources, customization that allows the service provider to offer a distinctive platform that will attract customers to them has not been available. Further end user customization remains impracticable.

Systems and methods disclosed herein provide a communication system for customizing component-based applications on devices to obviate or mitigate at least some of the aforementioned disadvantages.

### BRIEF DESCRIPTION OF THE DRAWINGS

An embodiment of the patent disclosure will now be described by way of example only with reference to the following drawings in which:

FIG. 1 is schematic diagram of a network facilitating wireless component applications;

FIG. 2 is a detailed component diagram of the application gateway shown in FIG. 1;

FIG. 3 is a flow diagram of a wireless component application communication model;

FIG. 4 is a sequence diagram of a communication sequence for the wireless component application communication model of FIG. 3;

FIG. 5 is a component diagram of a network as shown in FIG. 1 for providing a mobile runtime environment with default customized services in accordance with a first embodiment of the present patent disclosure; and

FIG. 6 is a component diagram of a network as shown in FIG. 1 for providing a mobile runtime environment with default customized services in accordance with a second embodiment of the present patent disclosure.

### DETAILED DESCRIPTION OF THE PREFERRED EMBODIMENT

In accordance with an aspect of the present patent disclosure, there is provided a system for customizing services on wireless devices. The system comprises a device and an application gateway server for communicating with the device. The device having a device runtime environment having core services, a default system application and at least one custom system application. The application gateway server configured for communication with a default back-end service and at least one custom back-end service. The at least one custom back-end service provides customized services to the device.

In accordance with another aspect of the present patent disclosure, there is provided a method of customizing services on a device. The method comprising the steps of configuring a device runtime environment with core services, a default system application and at least one custom system application, and communicating with at least one custom back-end service to customize services of the device.

In accordance with another aspect of the present patent disclosure, there is provided a computer-readable medium storing instructions or statements for use in the execution in a computer of a method of customizing services on a device. The method comprising the steps of configuring a device runtime environment with core services, a default system application and at least one custom system application, and communicating with at least one custom back-end service to customize services of the device.

In accordance with another aspect of the present patent disclosure, there is provided a propagated signal carrier carrying signals containing computer-executable instructions that can be read and executed by a computer. The computer-executable instructions are used to execute a method of customizing services on a device. The method comprising the steps of configuring a device runtime environment with core services, a default system application and at least one custom system application, and communicating with at least one custom back-end service to customize services of the device.

Accordingly the present patent disclosure provides for customizing in an easy, declarative fashion core mobile services that require user intervention.

Some services require user interaction (e.g., Application Control, Application Provisioning, Application Discovery, Runtime Environment (RE) updates) and most of these require communication with a back-end infrastructure. In these cases it is desirable for the application ‘Mobile Runtime Environment’ to offer access APIs to these services so that wireless ‘system applications’ can be built declaratively to use the same patterns consistently to provide a rich user experience and an enhanced look and feel.

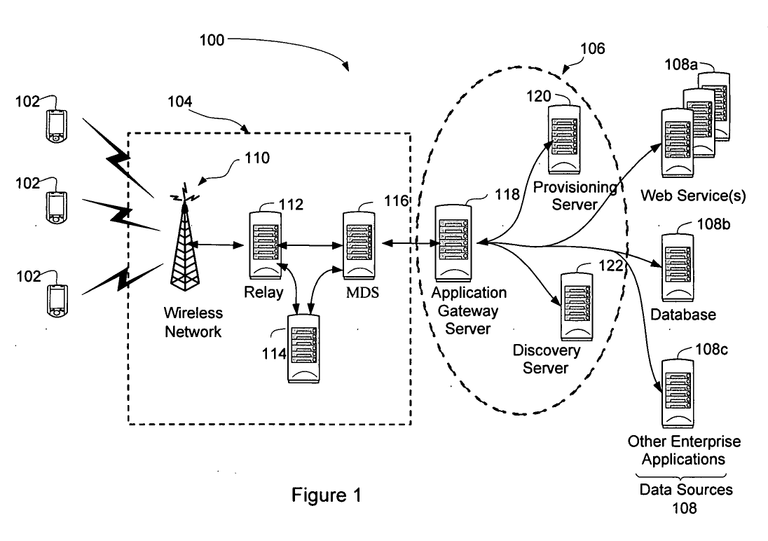

For convenience, like numerals in the description refer to like structures in the drawings. Referring to FIG. 1, a communication infrastructure is illustrated generally by numeral 100. The communication infrastructure 100 comprises a plurality of wireless devices 102, a communication network 104, an application gateway 106, and a plurality of back-end services 108.

The wireless devices 102 are typically personal digital assistants (PDAs), such as a BlackBerry™ by Research in Motion for example, but may include other devices. Each of the wireless devices 102 includes a runtime environment capable of hosting a plurality of component applications.

Component applications comprise one or more data components, presentation components, and/or message components, which are written in a structured definition language such as Extensible Markup Language (XML). The component applications can further comprise workflow components which contain a series of instructions such as written in a subset of ECMAScript, and can be embedded in the XML in some implementations. Therefore, since the applications are compartmentalized, a common application can be written for multiple devices by providing corresponding presentation components without having to rewrite the other components. Further, large portions of the responsibility of typical applications are transferred to the runtime environment for the component application. The details of the component applications are described at the end of this description.

The wireless devices 102 are in communication with the application gateway 106 via the communication network 104. Accordingly, the communication network 104 may include several components such as a wireless network 110, a relay 112, a corporate server 114 and/or a mobile data server 116 for relaying data between the wireless devices 102 and the application gateway 106.

The application gateway 106 comprises a gateway server 118 a provisioning server 120 and a discovery server 122. The gateway server 118 acts as a message broker between the runtime environment on the wireless devices 102 and the back-end services 108. The gateway server 118 is in communication with both the provisioning server 120 and the discovery server 122. The gateway server 118 is further in communication with a plurality of the back-end services 108, such as Web services 108a, database services 108b, as well as other enterprise services 108c, via a suitable link. For example, the gateway server 118 is connected with the Web services 108a and database services 108b via Simple Object Access Protocol (SOAP) and Java Database Connectivity (JDBC) respectively. Other types of back-end services 108 and their corresponding links will be apparent to a person of ordinary skill in the art.

Each wireless device 102 is initially provisioned with a service book establishing various protocols and settings, including connectivity information for the corporate server 114 and/or the mobile data server 116. These parameters may include a Uniform Resource Locator (URL) for the application gateway server 118 as well as its encryption key. Alternately, if the wireless device 102 is not initially provisioned with the URL and encryption key, they may be pushed to the wireless device 102 via the mobile data server 116. The mobile device 102 can then connect with the application gateway 106 via the URL of the application gateway server 118.

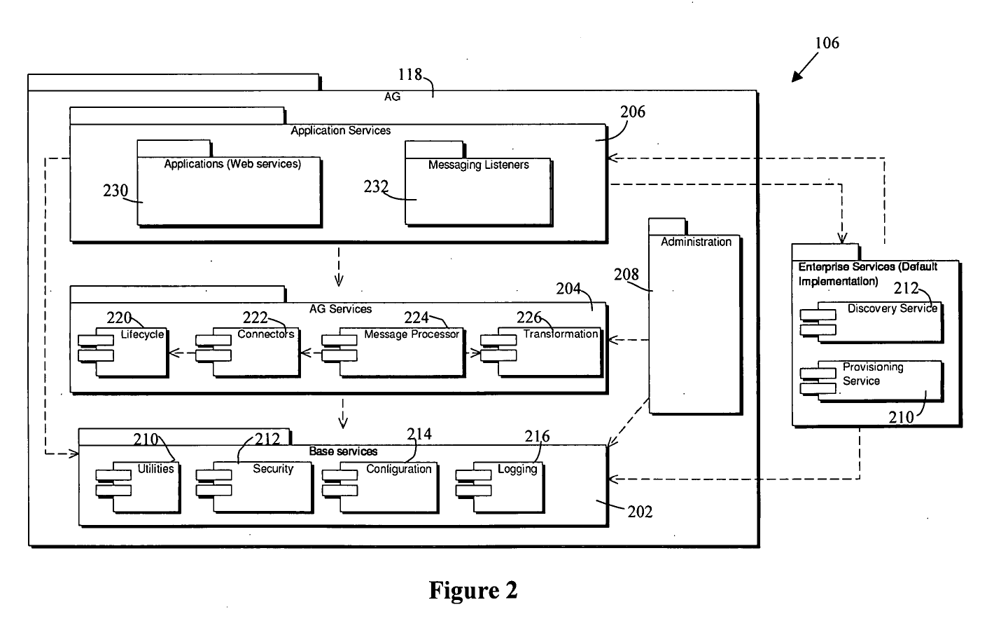

Referring to FIG. 2, a more detailed view of the application gateway 106 is shown. The application gateway server 118 includes three layers of service; a base services layer 202, an application gateway services layer 204 and an application services layer 206. The application gateway server 118 further includes an administration service 208.

The provisioning server 120 and discovery server 120 provide a provisioning service 210 and a discovery service 212, respectively.

At the lowest level, the base services layer 202 offers basic, domain independent system services to other components in higher levels. Thus, for example, all subsystems in the application gateway services layer 204 and the application services layer 206 can utilize and collaborate with the subsystems in the base services layer 202. In the present embodiment, the base services layer 202 includes a utilities subsystem 210, a security subsystem 212, a configuration subsystem 214, and a logging subsystem 216.

The application gateway services layer 204 provides wireless component application domain specific services. These services provide efficient message transformation and delivery to back-end services 108 and provide wireless device 102 and component application lifecycle management. In the present embodiment, the application gateway services layer 204 includes a lifecycle subsystem 220, a connector subsystem 222, a messaging subsystem 224, and a transformation subsystem 226.

The application services layer 206 sits at the top of the architecture and provides external program interfaces and user interfaces using subsystems provided by the lower layers. For example, various applications such as a service provider lifecycle application, a packaging application and a message listening application provide external program interfaces since they communicate primarily with applications on external systems. Similarly, an administration application provides a user interface by providing a user with ability to access and potentially modify application gateway data and/or parameters.

The administration service 208 is responsible for administrative system messages, administration of the wireless devices 102, runtime administration of the application gateway subsystems, support and display system diagnostics, and administration of default implementations of the provisioning and discovery services.

The message listening application provides an interface for receiving messages from the wireless devices 102 as well as external sources and forwarding them to the messaging subsystem. Further, the message listening application typically authenticates that the source of the message is valid and filters out intrusions.

The security subsystem 212 providing services used by other subsystems for securing communications with the wireless device 102. In order to facilitate secure communications, the security subsystem 212 encrypts and decrypts messages, validates signatures and signs messages.

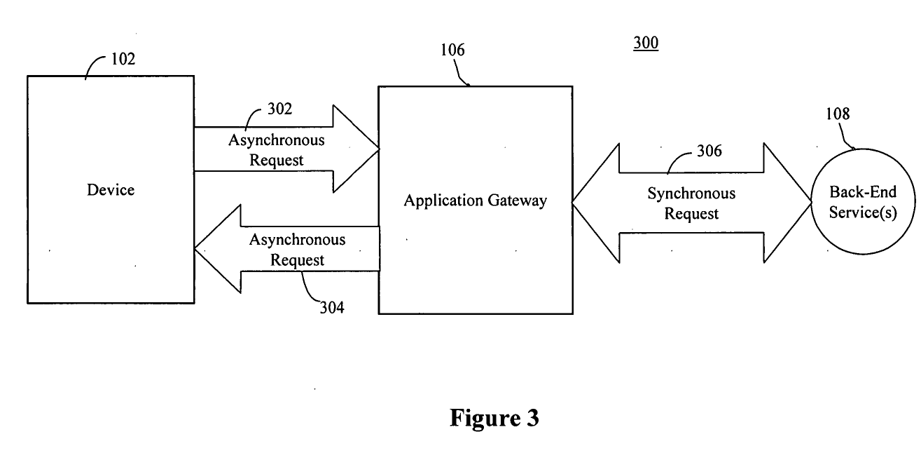

Referring to FIG. 3 there is illustrated in a flow diagram a wireless component application communication model. From a high-level perspective, the overall wireless component application infrastructure 300 includes a wireless component application runtime environment (Device RE) running on the device 102 and a wireless component application gateway (AG) 106 running on the server 118.

The AG 106 serves as a mediator between a wireless component application (sometimes referred to as application in this disclosure) executed by the RE and one or more back-end services 108 with which the application communicates. Often the back-end service is expected to be a Web service 108a using SOAP over HTTP or HTTPS as the transport protocol. As Web services are the most commonly expected back-end service 108, the term Web service is used interchangeable with back-end service 108 throughout this disclosure. However, it is appreciated that other types of back-end services can also be adapted to the disclosure. FIG. 3 exemplifies a synchronous link with a back-end service 108. However, it should be appreciated that the AG 106 can be in communication with back-end services 108 over asynchronous links.

The wireless component application communication model 300 is based upon an asynchronous messaging paradigm. In this model the AG 106 establishes and mediates the connection between the device 102 and the back-end service(s) 108 to:
1. Achieve greater flexibility in resource management.
2. Provide reliable communication link between device 102 and back-end service 106 to handle situations when wireless coverage is unstable.
3. Efficiently distribute the workload between device RE 102 and AG 106.

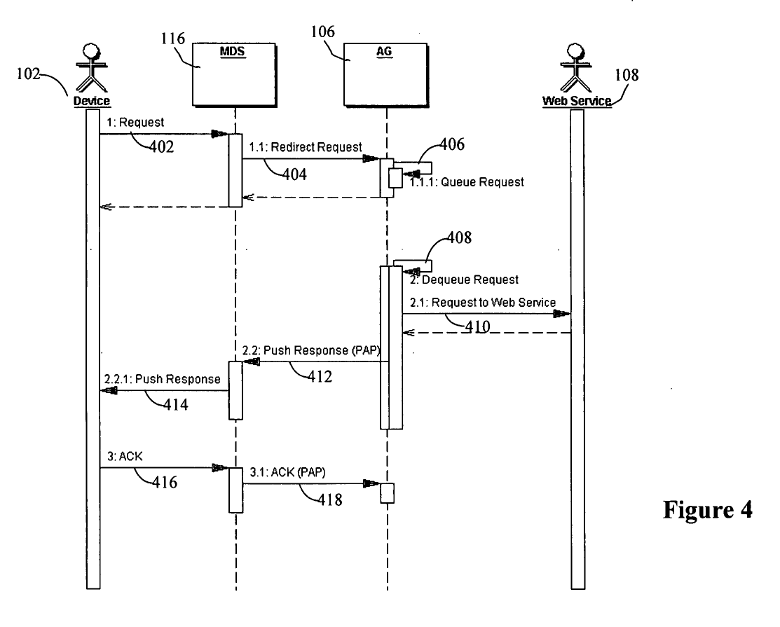

Referring to FIG. 4 there is illustrated in a sequence diagram a communication sequence for the wireless component application communication model of FIG. 3. The diagram describes the communications sequence between the device 102 and the back-end service(s) 108:
Upon receiving a request 402 from the device 102, via 404 MDS 116, AG 106 queues the request 406 and releases the connection to the device.
Next, the request is retrieved from the queue 408, pre-processed and forwarded 410 to the back-end service 108 through a synchronous communication channel.
Any response from the previous request is processed by AG 106 and a response message is sent asynchronously 412 and 414 back to the device.

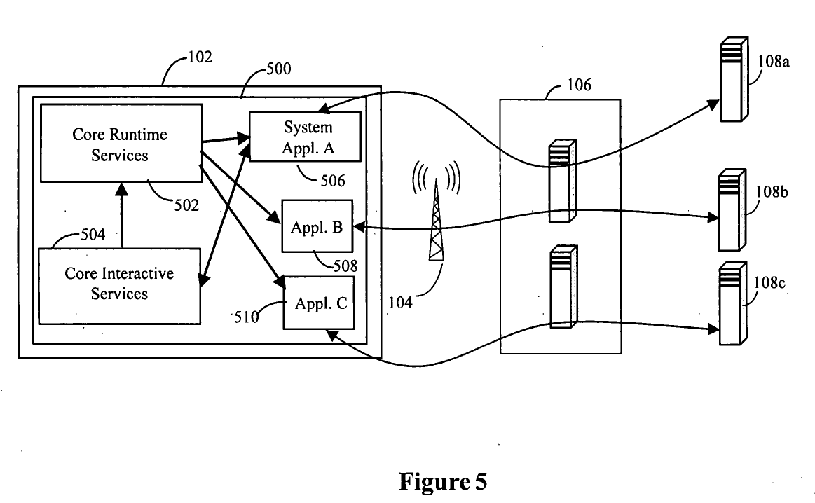

Referring to FIG. 5 there is illustrated in a component diagram of a network for providing a mobile runtime environment with custom default services, in accordance with a first embodiment of the present patent disclosure. The mobile runtime environment (RE) 500 has core runtime services 502 and a set of default interactive services 504, for example, provisioning and discovery. These interactive services 504 are customized for the mobile operator desired look and feel. Although they can be replaced at any time, once in place the mobile RE 500 uses them as defaults.

These services use mobile RE APIs to provide the core service 502, but have custom UI, data and (if needed) messaging modules for communicating to custom default back-end services 108b and 108c. The device 102 uses these services by default.

The back-end services 108 implementation is independent of the mobile framework and can be customized to the operator needs.

The mobile runtime environment 500 running on the handheld 102 is configured to run a set of default services 504 that are customized for the current mobile operator. Acting as a pair, the system application A 506 and the default system back-end service 108a can be replaced as long as the replacement mobile application satisfies the requirements outlined below.

In this case, the AG 106 may have prior knowledge of some or all default system applications 506 so that it can interact directly with them in some cases.

Application B 508 and application C 510 in the FIG. 5 are both installed by the mobile RE 500 using a default provisioning application (i.e., system application) A 506.

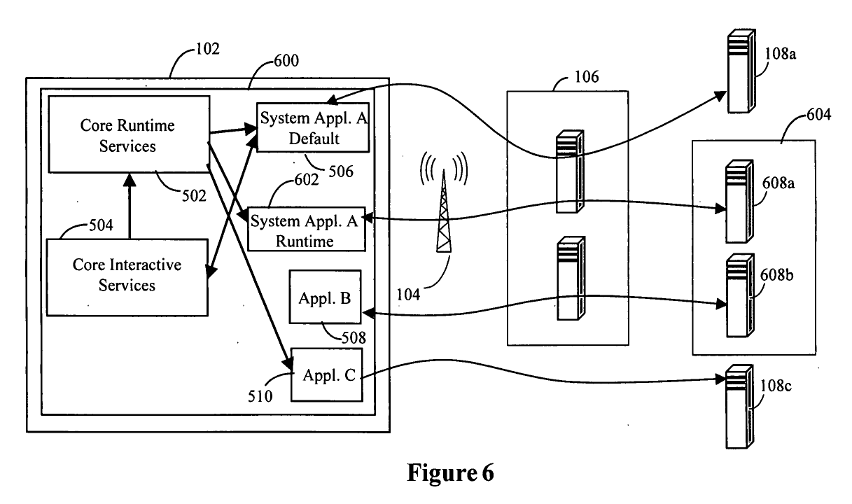

Referring to FIG. 6 there is illustrated in a component diagram of a network for providing a mobile runtime environment 600 with one or more default services 504 and one or more custom services 502, in accordance with a second embodiment of the present patent disclosure. The same interactive services 504 can be customized at runtime by back-end service 604 and used dynamically by mobile RE 600 on device 102, solving such issues as branding, liability and billing.

Preferably, these services are installed on the device 102 on demand and are short-lived (used to provide customized service for a specific application).

In operation, the mobile operator offers by a default provisioning service (system application) A 506. The default service (system application) 506 is used to install application C 510 on the device 102.

Application B 508 on the other hand, requires a custom provisioning service (system application) 602 (same service A) that is provided for a short time (just to install application B) by back-end service B 608b at external site 1 (604). The mobile RE 600 detects that application B 508 needs a special system service 602 by reading this application's descriptor ahead of its installation. The provisioning service described above is an example of a service that is customizable at run time and used momentarily by the RE 600.

The AG 106 does not need to have prior knowledge of these system applications as they are dynamically installed on the device 102 through the same process as all other regular applications.

For example, consider an application described in XML that has the following characteristics:
has a set of data components described in XML
has a set of message components described in XML
has a set of UI components and workflow scripts that manipulate the data and messages

In order for this application to qualify as a system application 602 (custom system), it should satisfy these requirements:
Identify itself as a system service in its descriptor
Use specific data components (required for the specific service) to feed data from/into Mobile RE 600
Use specific external APIs provided by the Mobile RE 600 to communicate above data, for example through script calls.

As well as these requirements, a system application may define any other constructs it wishes to use for further interaction with the user or the back-end service. This includes screens, data, scripts or messages.

The following is an example of a provisioning application:

```
<!DOCTYPE mobileApp SYSTEM “mobileApp.dtd”>
<app uri=“site1.com/site1Provioning” name=“Site1Provisioning” main=“scr_Main” vendor=“Site1” version=“1.1.0”
>
  <!-- Provisioning Request -->
  <data name=“InstallInfo”>
    <field name=“packageUrl” type=“string”/>
    <field name=“appName” type=“string”/>
    <field name=“dd” type=“data” component=“DeploymentDescriptor”/>
  </data>
  <!-- AppDescriptor Data -->
  <data name=“DeploymentDescriptor”>
    <field name=“appURL” type=“string” array=“false”/>
    <field name=“appName” type=“string” array=“false”/>
    <field name=“vendor” type=“string” array=“false”/>
    <field name=“isProvisioningService” type=“boolean” array=“false”/> <!-- this field may indicate
to Mobile RE that this wireless component application is accomplishing a system service i.e. Provisioning -->
  <field name=“externalProvisioningUrl” type=“string” array=“false”/> <!-- this field may indicate
to Mobile RE that this wireless component application requires external provisioning service -->
    <field name=“description” type=“string” array=“false”/>
    <field name=“wicletUsername” type=“string” array=“false”/>
    <field name=“wicletVersion” type=“string” array=“false”/>
  </data>
  <!-- Web service data -->
  <!-- Get Package Information Data -->
  <data name=“PackageInfo”>
    <field name=“appName” type=“string”/>
    <field name=“appUrl” type=“string”/>
  </data>
  <!-- Get Package Information Response Data -->
  <data name=“PackageResponseInfo”>
    <field name=“appId” type=“string”/>
    <field name=“packageUrl” type=“string”/>
  </data>
  <data name=“ProvisionWicletResponse” persist=“false” key=“”>
    <field name=“responseInfo” type=“data” component=“PackageResponseInfo” array=“false”/>
  </data>
<screen name=“scr_Main” dialog=“false” layout=“vertical” title=“Main Screen”> <!---custom application main
screen -->
...
</screen>
...
<script name=“script_inGetRandomBushismResponse_onMsgArrive”/>
<script name=“script_outGetRandomBushismRequest_onSubmit”/>
<script name=”script_onProvisioningRequest”/> <!--core interactive services called directly from these scripts -->
<script name=”script_onGetPackageResponse” />
</wiclet>
```

The system and methods according to the present patent disclosure may be implemented by any hardware, software or a combination of hardware and software having the above described functions. The software code, either in its entirety or a part thereof, may be stored in a computer readable memory. Further, a computer data signal representing the software code which may be embedded in a carrier wave may be transmitted via a communication network. Such a computer readable memory and a computer data signal are also within the scope of the present patent disclosure, as well as the hardware, software and the combination thereof.

While particular embodiments of the present patent disclosure have been shown and described, changes and modifications may be made to such embodiments without departing from the true scope of the patent disclosure.

What is claimed is:

1. A system for customizing services on wireless devices, the system comprising:
a device having a device runtime environment having:
core services;
a default system application; and
at least one custom system application; and
an application gateway server for communicating with the device, the application gateway server configured for communication with a default back-end service and at least one custom back-end service, the at least one custom back-end service providing customized services to the device.

2. The system as claimed in claim 1, wherein the default system application is preconfigured.

3. The system as claimed in claim 1, wherein the a custom system application of the at least one custom system application is preconfigured.

4. The system as claimed in claim 1, wherein a custom system application of the at least one custom system application is activated at runtime.

5. The system as claimed in claim 4, wherein the custom system application is capable of runtime customization.

6. The system as claimed in claim 1, wherein a custom system application of the at least one custom system application is installed at runtime in response to a request.

7. The system as claimed in claim 1, wherein a custom system application of the at least one custom system application permits downloading of applications from the at least one custom back-end service.

8. The system as claimed in claim 1, wherein a custom system application of the at least one custom system application permits discovery of applications from the at least one custom back-end service.

9. A method of customizing services on a device, the method comprising the steps of:
configuring a device runtime environment with:
core services;
a default system application; and
at least one custom system application; and
communicating with at least one custom back-end service to customize services of the device.

10. The method as claimed in claim 9, further comprising the step of activating the at least one custom system application at runtime.

11. The method as claimed in claim 9, further comprising the step of customizing the runtime environment using the at least one custom system application.

12. The method as claimed in claim 9, further comprising the step of downloading an application using the at least one custom application.

13. The method as claimed in claim 9, further comprising the step of discovering an application using the at least one custom application.

14. The method as claimed in claim 9, further comprising the step of installing an application using the at least one custom application.

15. A computer-readable medium storing instructions or statements for use in the execution in a computer of a method of customizing services on a device, the method comprising the steps of
configuring a device runtime environment with:
core services;
a default system application; and
at least one custom system application; and
communicating with at least one custom back-end service to customize services of the device.

16. A propagated signal carrier carrying signals containing computer-executable instructions that can be read and executed by a computer, the computer-executable instructions being used to execute a method of customizing services on a device, the method comprising the steps of:
configuring a device runtime environment with:
core services;
a default system application; and
at least one custom system application; and
communicating with at least one custom back-end service to customize services of the device.
